(19) United States
(12) Patent Application Publication
(10) Pub. No.: US 2008/0089299 A1
(43) Pub. Date: Apr. 17, 2008

(54) Method and system for distributing content in Ad-hoc networks using super peers

(75) Inventors: Brett L. Lindsley, Wheaton, IL (US); Bogdan O. Carbunar, Schaumburg, IL (US); Richard M. Clayton, Phoenix, AZ (US); Venugopal Vasudevan, Palatine, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/549,151

(22) Filed: Oct. 13, 2006

(51) Int. Cl. H04Q 7/24

(52) U.S. Cl. 370/338

(57) ABSTRACT

A system (150) and method (200) for peer-to-peer content sharing in an ad-hoc network is provided. The system can include a plurality of peers (102) and a super peer (110). The super peer provides a continuous power supply (112) and mass storage (111) for distributing and caching shared content. The super peer can monitor (202) a plurality of requests for content, identify (204) popular content from the plurality of requests, and distribute (214) the popular content to the peers to offload content sourcing responsibilities. The super peer can manage a want-list (320), a popularity-list (330), and a source-list (340) for acquiring and distributing popular content.

### FIELD OF THE INVENTION

The present invention relates to mobile communication systems and, more particularly, to ad-hoc networking.

### BACKGROUND

Ad-hoc networking can be an efficient and reliable way to route data between nodes in a network. Ad-hoc networking allows for continuous connections and reconfiguration within a network by allowing hopping from node to node until a connection can be established. Ad-hoc networks are decentralized, relatively inexpensive, generally reliable, and resilient, as each node need only transmit as far as the next node. That is, nodes act as repeaters to transmit data from nearby nodes to peers that are too far away to reach, resulting in a network that can span large distances. Ad-hoc networks are reliable in that each node can connect to several other nodes. Ad-hoc networks can also provide communication when a node becomes inoperable or a connection is terminated, as there are other nodes through which the data can be routed. For example, if one node drops out of the network, due to hardware failure or other reasons, the node's neighbors can search another route. Moreover, extra capacity can be installed by simply adding more nodes.

Ad-hoc networks are generally associated with wireless networks and wired networks. For example, a Wireless LAN (WLAN) is a local area network that uses radio frequencies to communicate between wireless enabled devices. As one example, the IEEE 802.11 (“Wi-Fi”) wireless protocol can support an ad hoc networking system when no wireless access points are present. Wireless Ad hoc networks are self-forming networks and include a number of nodes which can operate with or without any fixed infrastructure. In some cases the ad hoc network can be formed entirely of mobile nodes. The nodes can be fixed or mobile and can communicate with each other over a wireless media with or without the support of an infrastructure-based or wired network.

Nodes may operate in two modes in an ad hoc network i.e. an infrastructure mode and a peer-to-peer mode. In infrastructure mode, typically only one communication hop is used from a mobile node to an access point (AP) or other base station (i.e. a special node with an infrastructure connection). In the peer-to-peer mode, devices can manage themselves without the need for central control, such as a wireless access point. For example, a wireless connection can be established for the duration of a session without connection through a wireless access point. Instead, devices can discover other devices within range to form a wireless network for those devices. Devices may search for target nodes that are out of range by flooding the network with broadcasts that are forwarded by each node. For example, devices can communicate directly with one another making connections with one another over multiple nodes (multihop ad hoc network) without a wireless access point.

Ad-hoc networking also provides a readily means for sharing content within a local wireless community. Peers within the ad-hoc network can act as sources or consumers, wherein source nodes provide content, and consumer nodes receive content. Sourcing content consumes processing overhead which can reduce battery power. That is, peers have limited power capacity to source content for others. As a result, mobile devices may be cautious in sourcing content. Accordingly, mobile device resources are conserved in peer-to-peer content sharing in an ad-hoc network. Moreover, the number of peers sourcing content may decrease due to peers leaving the environment, or peers reserving battery power to gather content rather than expending power to source content. Thus, the number of peers available to source content decreases over time, whereas the number of peers that want content does not decrease.

### SUMMARY

Broadly stated, embodiments of the invention are directed to a method and system for distributing popular content in a peer-to-peer ad-hoc network. In particular, popular content can be distributed via one or more super peers that identify popular content and source the popular content. The super peers have a power and memory capacity that allows popular content to be sourced when peers within the ad-hoc network may be unable to source content due to limited battery power or data throughput. The super peers can implement a method for peer-to-peer content file sharing for distributing content. The method can include monitoring a plurality of requests from a plurality of peers, identifying popular content from the plurality of requests, sourcing the popular content from at least one peer, and distributing the popular content to the plurality of peers. The method for peer-to-peer content file sharing can offload sourcing responsibilities of the at least one peer for preserving a battery life of the peer.

In one aspect, a super peer can create a want-list based on requests for popular content. In another aspect, the want-list can be created by peers within a peer-to-peer environment. The want-list for content can be broadcast to the plurality of peers for identifying peers that can source the content. A peer can be contacted in the ad-hoc network for providing the popular content. The super peer can then source the popular content from the peer and then distribute the popular content to the plurality of peers. This allows the super peer to offload content sourcing responsibilities thereby preserving a resource of the peer, such as a battery life. In one aspect, a reward can be offered to a peer originally providing the common content, or seeking and sourcing requested content.

Embodiments of the invention are also directed to a method for distributing content. Briefly, the method identifies a capacity for storing and distributing popular content. The method can include creating or receiving a want list for content from a plurality of peers, assessing a popularity of the content from the want list, evaluating a capacity for storing the content based on the popularity, and sourcing the content based on the capacity and the popularity. In one aspect, the super peer can distribute content to the plurality of peers in accordance with the capacity and the popularity. The super peer can acquire the popular content from at least one peer, and then source content to other peers to offload content sourcing responsibilities. The method can include rating the content to produce a popularity list, determining whether popular content is available, and computing a storage capacity for the popular content. The broadcasted want-list can be updated based on the availability of content and the storage capacity to produce an updated want list. The updated want list can be re-broadcast, and at least one peer capable of sourcing the content can be identified. A source list can be created that identifies peers capable of sourcing the content. The source list can be sorted in accordance with the popularity list, and peers capable of sourcing the content can be identified. The super peer can acquire the popular content from the peers for distribution.

Embodiments of the invention are also directed to a super peer for identifying and distributing popular content to a plurality of peers. The super peer can include a processor for managing a want-list that identifies content wanted by the plurality of peers, managing a popularity list that ranks the content in the want-list by popularity, and managing a source list that identifies peers capable of sourcing the content. The super peer can include a monitor for monitoring battery power levels of the plurality of peers, and overtaking sourcing responsibilities when a battery power level of the peer falls below a threshold. The super peer can include a memory management module for evaluating a capacity for popular content and freeing storage capacity for acquiring the content, and a loading module operatively coupled to the memory management module for acquiring popular content from a peer and sourcing the popular content to the plurality of peers based on the capacity.

### BRIEF DESCRIPTION OF THE DRAWINGS

The features of the system, which are believed to be novel, are set forth with particularity in the appended claims. The embodiments herein, can be understood by reference to the following description, taken in conjunction with the accompanying drawings, in the several figures of which like reference numerals identify like elements, and in which:

FIG. 1 is a system for an ad hoc wireless network including a plurality of nodes employing a system and method in accordance with an embodiment of the present invention;

FIG. 2 is a block diagram illustrating an example of a mobile node employed in the network shown in FIG. 1;

FIG. 3 is a peer-to-peer ad-hoc environment in accordance with an embodiment of the present invention;

FIG. 4 is a peer-to-peer ad-hoc environment including a super peer in accordance with an embodiment of the present invention;

FIG. 5 is a schematic for requesting and sharing content in accordance with an embodiment of the present invention;

FIG. 6 is another schematic for requesting and sharing content in accordance with an embodiment of the present invention;

FIG. 7 is a method for peer-to-peer content sharing in accordance with an embodiment of the present invention;

FIG. 8 is a plot for evaluating a popularity of shared content in accordance with an embodiment of the present invention;

FIG. 9 is a plot for ranking content by populatiry in accordance with an embodiment of the present invention;

FIG. 10 is a popularity-list in accordance with an embodiment of the present invention;

FIG. 11 is a want-list in accordance with an embodiment of the present invention;

FIG. 12 is a schematic for broadcasting requests for content in accordance with an embodiment of the present invention;

FIG. 13 is a source-list in accordance with an embodiment of the present invention;

FIG. 14 is a block diagram of a super peer in accordance with an embodiment of the present invention;

FIG. 15 is a flowchart for peer-to-peer content sharing in accordance with an embodiment of the present invention; and

FIG. 16 is a block diagram for a super peer distributing content to other peers.

### DETAILED DESCRIPTION

While the specification concludes with claims defining the features of the embodiments of the invention that are regarded as novel, it is believed that the method, system, and other embodiments will be better understood from a consideration of the following description in conjunction with the drawing figures, in which like reference numerals are carried forward.

As required, detailed embodiments of the present method and system are disclosed herein. However, it is to be understood that the disclosed embodiments are merely exemplary, which can be embodied in various forms. Therefore, specific structural and functional details disclosed herein are not to be interpreted as limiting, but merely as a basis for the claims and as a representative basis for teaching one skilled in the art to variously employ the embodiments of the present invention in virtually any appropriately detailed structure. Further, the terms and phrases used herein are not intended to be limiting but rather to provide an understandable description of the embodiment herein.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “processing” can be defined as number of suitable processors, controllers, units, or the like that carry out a pre-programmed or programmed set of instructions. The terms “program,” “software application,” and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system. The term “infrastructure mode” can be defined as an ad hoc network comprising at least one mobile device that is not more that one hop from a mobile node, an access point, or base station. The term “peer mode” can be defined as an ad hoc network wherein mobile devices communicate with other mobile devices without central control and are at least one hop from a mobile node, an access point, or base station.

Briefly, embodiments of the invention are directed to a super peer, and a method for distributing content in a peer-to-peer ad-hoc network using a super peer. In particular, the super peer has significant power capabilities and storage capacity. The super peer is not limited by battery life or memory requirements in comparison to peers in the ad-hoc network. This allows the super peer to continually source content when other peers may be limited to sourcing content due to battery life. In practice, the super peer can monitor peer-to-peer requests in the ad-hoc network and identify content that is popular from the requests. The super peer can acquire and manage the popular content from peers originally sourcing the content. The super peer can store the popular content and distribute it within the ad-hoc network to offload sourcing on the peers.

In one aspect, the super peer offers peer-to-peer file sharing and proactive storage of popular items. The super peer can be introduced ad-hoc networks where there is generally no central place for a traditional cache. The peer-to-peer file sharing is particularly well suited for small and homogeneous peer-to-peer networks where all peers are able to communicate directly with one to another without a central control point such as a gateway, proxy or Wi-Fi hotspot. The super peer can gather content from traffic within the peer-to-peer network and store it for distribution, as the super peer is not a standard infrastructure component. The super peer provides caching in ad-hoc network configurations where local cache is unavailable. This includes ad-hoc networks with no entity centralizing communications such as a hotspot.

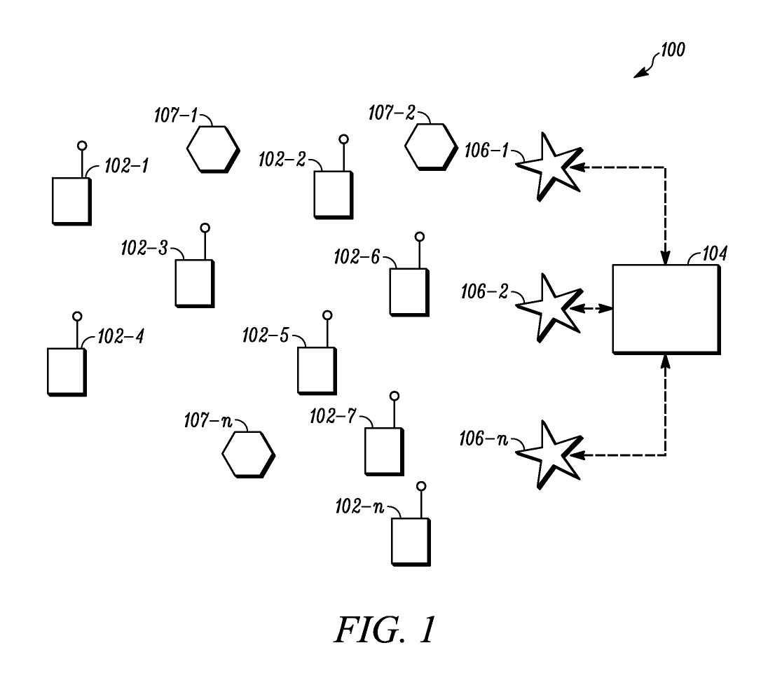

Referring to FIG. 1, a block diagram illustrating an example of an ad-hoc wireless network 100 is shown. Specifically, the network 100 includes a plurality of mobile wireless user terminals 102-1 through 102-n (referred to generally as nodes 102, peers 102, or mobile nodes 102), and can, but is not required to, include a fixed network 104 having a plurality of access points 106-1, 106-2, . . . 106-n (referred to generally as nodes 106, access points (APs) 106 or intelligent access points (IAPs) 106), for providing nodes 102 with access to the fixed network 104. The fixed network 104 can include, for example, a core local area network (LAN), and a plurality of servers and gateway routers to provide network nodes with access to other networks, such as other ad hoc networks, the public switched telephone network (PSTN) and the Internet. The network 100 further can include a plurality of fixed routers 107-1 through 107-n (referred to generally as nodes 107, wireless routers (WRs) 107 or fixed routers 107) for routing data packets between other nodes 102, 106 or 107. It is noted that for purposes of this discussion, the nodes discussed above can be collectively referred to as “nodes 102, 106 and 107”, or simply “nodes”. As can be appreciated by one skilled in the art, the nodes 102, 106 and 107 are capable of communicating with each other directly, or via one or more other nodes 102, 106 or 107 operating as a router or routers for packets being sent between nodes.

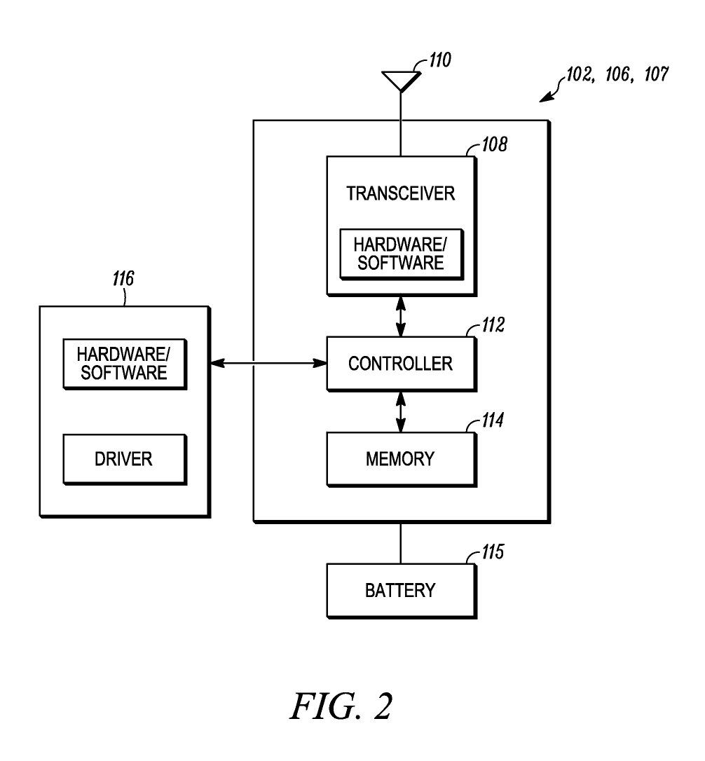

Referring to FIG. 2, an exemplary block diagram for one of the plurality of nodes 102 is shown. Each node 102 can include at least one transceiver or modem 108, which is coupled to an antenna 110 and is capable of receiving and transmitting signals, such as packetized signals, to and from the nodes 102, 106 or 107, under the control of a controller 112. The packetized data signals can include, for example, voice, data, multimedia information, instructions, and packetized control signals, including node update information. In particular, each node 102 includes a battery 115 which provides limited power. The battery 115 provides the power for the node 102 to transmit and receive data communications. For example, in ad-hoc peer-to-peer mode, the peers rely on the battery 115 for powering communication. Notably, sharing content between peers can reduce a life of the battery 115.

Each node 102, 106 and 107 further includes a memory 114, such as a random access memory (RAM) that is capable of storing, among other things, routing information pertaining to itself and other nodes in the network 100. The memory 114 can also store content such as music or files that may be shared as content with other peers in the ad-hoc peer-to-peer network. A display 118 can also be included for presenting battery levels associated with data communication. As further shown in FIG. 2, certain nodes, can include a host 116 which may consist of any number of devices, such as a notebook computer terminal, mobile telephone unit, mobile data unit, or any other suitable device. Each node 102 can include the appropriate hardware and software to perform Internet Protocol (IP) and Address Resolution Protocol (ARP), the purposes of which can be readily appreciated by one skilled in the art. The appropriate hardware and software to perform transmission control protocol (TCP) and user datagram protocol (UDP) may also be included. The nodes 102 within the network can form a wireless ad hoc network. A node can be a mobile device, a cell phone, a radio, a portable media player, a laptop, or any other suitable communication device.

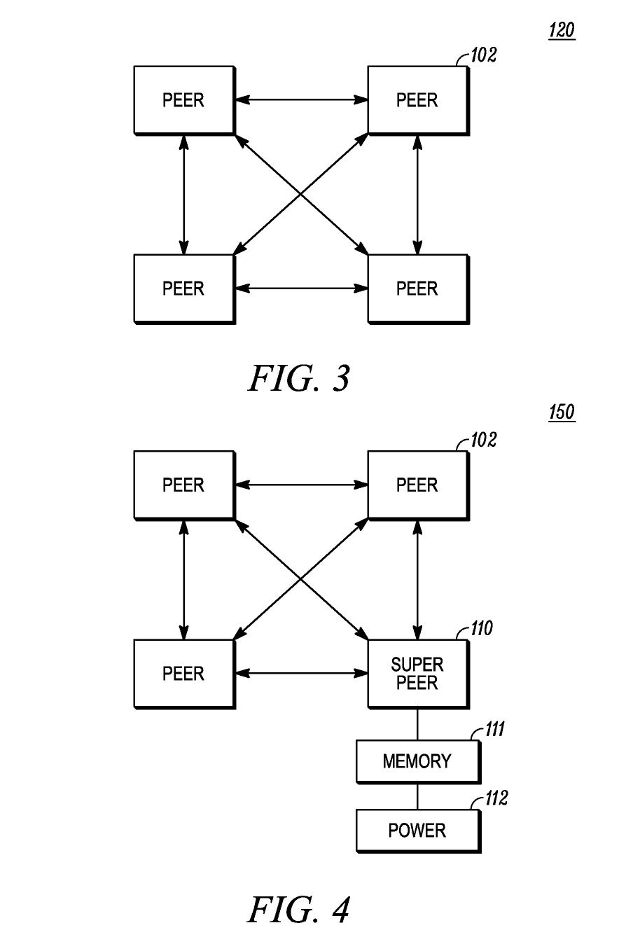

Referring to FIG. 3, an ad-hoc peer-to-peer (ahp2p) environment 120 is shown. The ah2p2p environment 120 can include peers 102 communicating individually with one another as shown. Briefly, the peers 102 of the ahp2p network 120 are the nodes 102 of the ad-hoc wireless communications network 100 shown in FIG. 1. In particular, the peers 102 are not in direct communication with routers 106 or other fixed network equipment 107 as shown in FIG. 1. In such regard, the peers 102 can form a small wireless community to share content in an area that may not provide network coverage. For example, the peers 102 may be in a remote area where wireless infrastructure connectivity is unavailable. Accordingly, the peers 102 share content amongst one another in an ahp2p environment 120 using closed wireless communication. For example, each of the peers can broadcast requests to the other peers for content. Peers may elect to source content or gather content in view of the requests.

Each of the peers 102 can appear the same to the other peers 102. That is, each peer has approximately the same resources to gather and source content as the other peers 102. In particular, because the peers 102 are also mobile devices, they have limited power capacity and data throughput. For example, referring back to FIG. 2, each of the peers 102 has a battery 115 that provides limited power. Although peers may both gather and source content, the number of peers sourcing content in the ahp2p environment 120 may decrease due to (1) peers leaving the environment, or (2) peers reserving battery power to gather content rather than expending power to source content. Thus, the number of peers available to source (e.g. provide) content decreases over time whereas the number of peers that want (e.g. consume) content does not decrease.

Referring to FIG. 4, another ad-hoc peer-to-peer (ahp2p) environment 150 in accordance with the embodiments of the invention is shown. In particular, the ahp2p environment 150 includes a super peer 110 which provides significant power capacity and data throughput. The super-peer can use the same protocols and appear “transparent” to all of the existing peers 102. That is, the peers 102 may or may not be aware of the presence of the super peer 110. Notably, the super-peer 110 provides capabilities of mass storage and is not generally limited by power consumption. For example, the super peer 110 can include a high-capacity memory module 111 and a high-power module 112. The high-power module may be plugged into a wall or powered from an external power source such as a vehicle battery. The super peer operation is compatible with the request exchange protocol and behaves as any other peer, with the exception that the super peer can gather and source an extraordinary amount of content. Accordingly, the ahp2p environment 150 is a portable environment in the sense that the peers 102 and the super peer 110 can form an ahp2p environment without dependence on infrastructure support.

Briefly, the super-peer 110 determines what content shared in the ahp2p environment 150 is popular based on current content requests being made in the ahp2p environment 150. Moreover, the super peer 110 can evaluate a redistribution probability of content for selecting popular content to distribute. Based on what content is most popular, the super-peer 110 can load the content transparently as any other peer. As other peers 102 discontinue sourcing due to limited resources, the super-peer 110 can source content due to it's significant resources, such as the memory module 111 and the high-power module 112. This allows content distribution within the ahp2p environment 150 to continue even though the peers 102 may be decreasing in resources. Moreover, the super peer 110 can offer rewards to peers originally sourcing content, or intentionally seeking and sourcing content that is popular. For example, certain peers within the group may be provided an incentive for sourcing popular content to the super peer 110. In one arrangement, a service provider can offer rewards to the peers sourcing content to the super peer. In another arrangement, the peers 102 can offer credits to other peers sourcing content. Notably, each device can gather as much content as it wants without penalty. In such regard, sourcing of content provides a “super distribution” rewards.

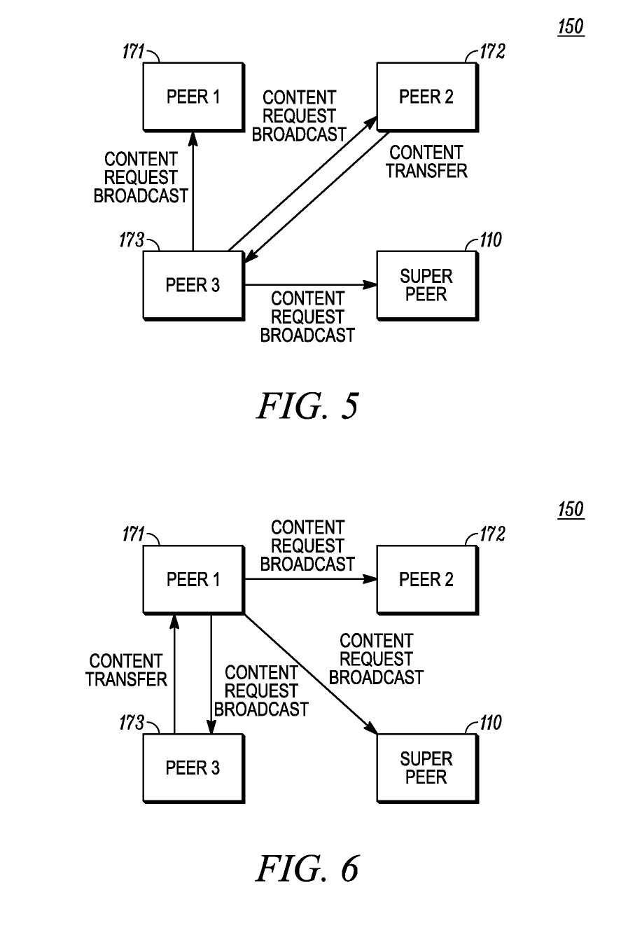

Referring to FIG. 5, an example for content request broadcasts and transfers in the ahp2p environment 150 is shown. Briefly, peers 171-173 within the ahp2p environment exchange requests for content, and fulfill content requests directly. That is, each peer attempts to either source or gather content individually. For instance, Peer 3 (173) sends a broadcast for content to all devices in the vicinity. That is, Peer 3 (173) makes a request to peers within the group for content. Some peers may or may not reply. For example, with regard to FIG. 5, peer 2 (172) responds with the content to peer 3 (173), whereas Peer 1 (171) elects not to respond. Super peer 110 may also receive the request for content but may not be able to respond because it may not have the requested content. It should be noted the list of content items a peer can source and the actual content item transferred is not visible to any other peer.

As another example, referring to FIG. 6, peer 1 (171) sends a broadcast for content to all devices in the vicinity. In this case, peer 3 (173) responds with the content to peer 1 (171), whereas peer 2 (172) elects not to respond. For instance, peer 3 may have the content, whereas peer 2 does not have the requested content. Again, the content transfer is not visible to other peers. It should be noted that the super peer 110 has also received both content requests, although it did not respond in this example.

Briefly, the super peer 110 can receive content requests from all surrounding peers 171-173. The super peer 110 can determine which content is the most popular, gather the most popular content, and redistribute the most popular content. In one arrangement, the super peer 110 can create a “want list”, which describes the content it wants to gather, based on what content is most popular and a storage requirement of the wanted content compared to the storage availability on the super peer. In practice, the super peer 110 attempts to fulfill the want list by broadcasting requests for the most popular content to other peers. If the super peer request for content is satisfied, the content item is provided to the super peer, and made available for distribution. Content items can be added to or taken off of the re-circulating want-list based on the popularity and the availability of the content. One objective of the super peer is to maximally fill the storage of the super peer with the most popular content. That is, the super peer continually monitors the requests and keeps the most popular content available for distribution.

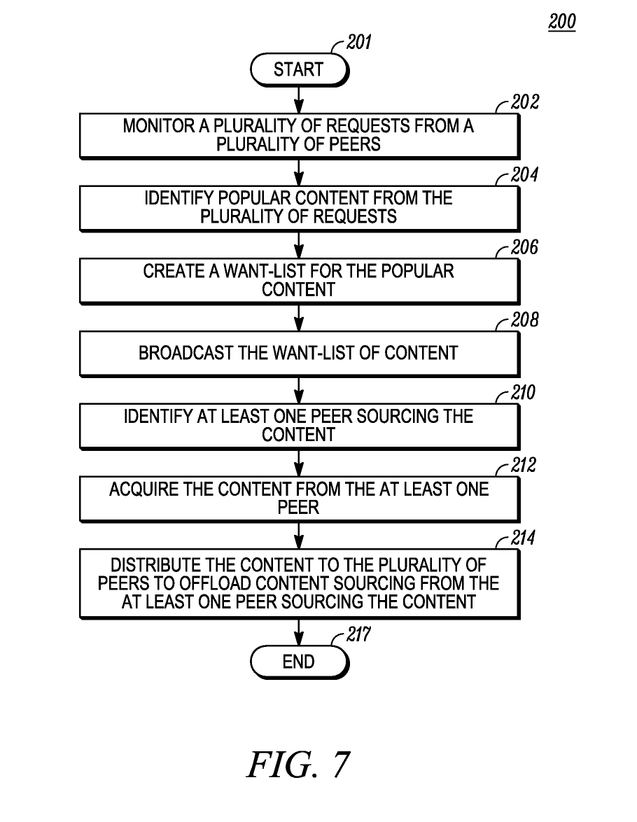

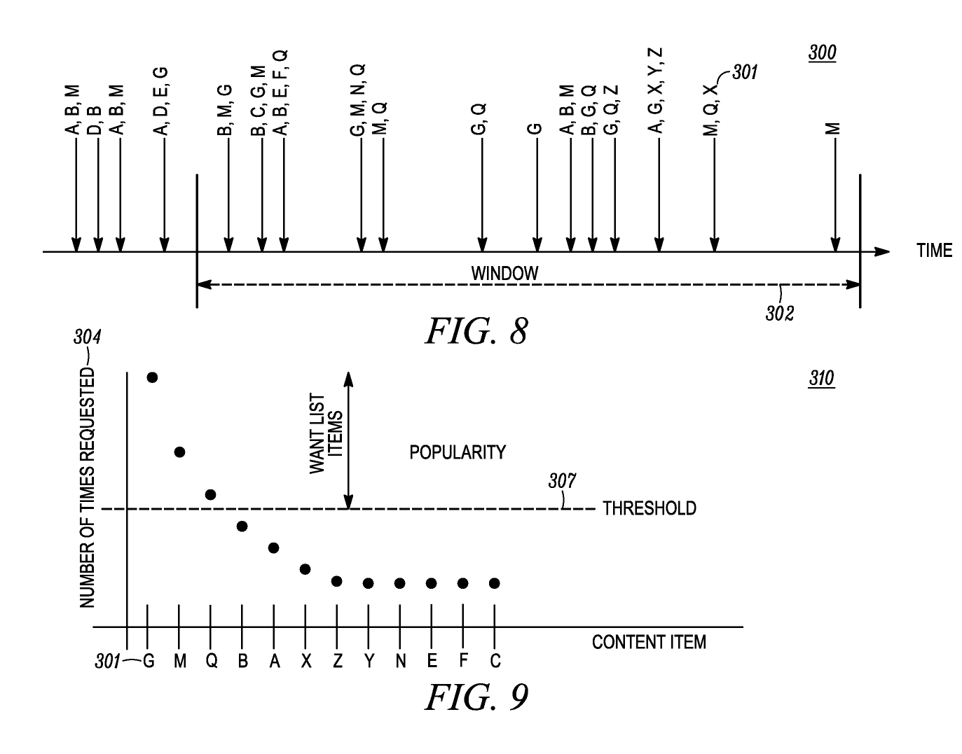

For example, referring to FIG. 7, a method 200 for peer-to-peer content sharing is shown. Briefly, the method 200 can be implemented by the super peer 110 for acquiring and distributing content in an ahp2p environment 150 (See FIG. 4). The super peer 110 can off load content sourcing responsibilities for other peers to preserve one or more resources of the peers. In practice, the method 200 can be implemented by the super peer 110 for content gathering and distribution. The method 200 may be practiced with more or less than the number of steps shown. To describe the method 200, reference will be made to FIGS. 8-13 although it is understood that the method 200 can be implemented in any other suitable device or system using other suitable components. Moreover, the method 200 is not limited to the order in which the steps are listed in the method 200 In addition, the method 200 can contain a greater or a fewer number of steps than those shown in FIG. 7.

At step 201, the method 200 can start. The method 200 can start in a state wherein many devices are exchanging content between themselves. For example, referring back to FIGS. 5 and 6, the peers 102 can send requests for content and share content amongst one another. Peers 102 can read each others requests and determine whether they have the requested content to share. As an example, a first peer may request a music song, and a second peer may receive the request for the music song. If the second peer has the music song, and is willing to share resources, the second peer can source the music song to the first peer. The super peer 110 can also receive requests for content sharing.

Returning back to FIG. 7, at step 202, a plurality of requests for content from a plurality of peers can be monitored. For example, referring back to FIG. 4, the super peer 110 can monitor requests for content that are exchanged in the ahp2p environment 150. Recall, the super peer 110 can also receive the requests because the super peer 110 is transparent to the peers 102. The requests may be in the form of data packets or messages transferred between the plurality of peers.

Returning back to FIG. 7, at step 204, popular content can be identified from the plurality of requests. Popular content can be identified by evaluating a number of requests for the content, rating the content by the number of requests, and identifying popular content from the rating. For example, the super peer 110 can evaluate a popularity of the content being requested. Briefly, referring to FIG. 8 an illustration 300 for rating content is shown. For example, requests for content 301 can be evaluated by a number of requests for the content over a window of time 302, and a rating can be assigned to the content based on the number of requests during the time window 302. A request for content 301 may be designated by an identifier such as A, D, G, E. The content identifier 301 may be a request for a song, a file, or any other suitable content. As another example, a request for content 301, such as identifier G or O, may be for a voice mail or email message.

Referring to FIG. 9, the content 301 can be ranked by popularity. For example, the content items 301 can be ranked by the number of requests 304 received for the content. A threshold 307 can also be included for determining whether content is popular. In particular, the super peer 110 may not wish to acquire content that is below the popular threshold 307. For instance, the super peer can determine the number of times a request for content was received during the window of time 302 as shown in FIG. 8 and compare it to the threshold 307. The super peer 110 can then create a popularity list based on the popular content.

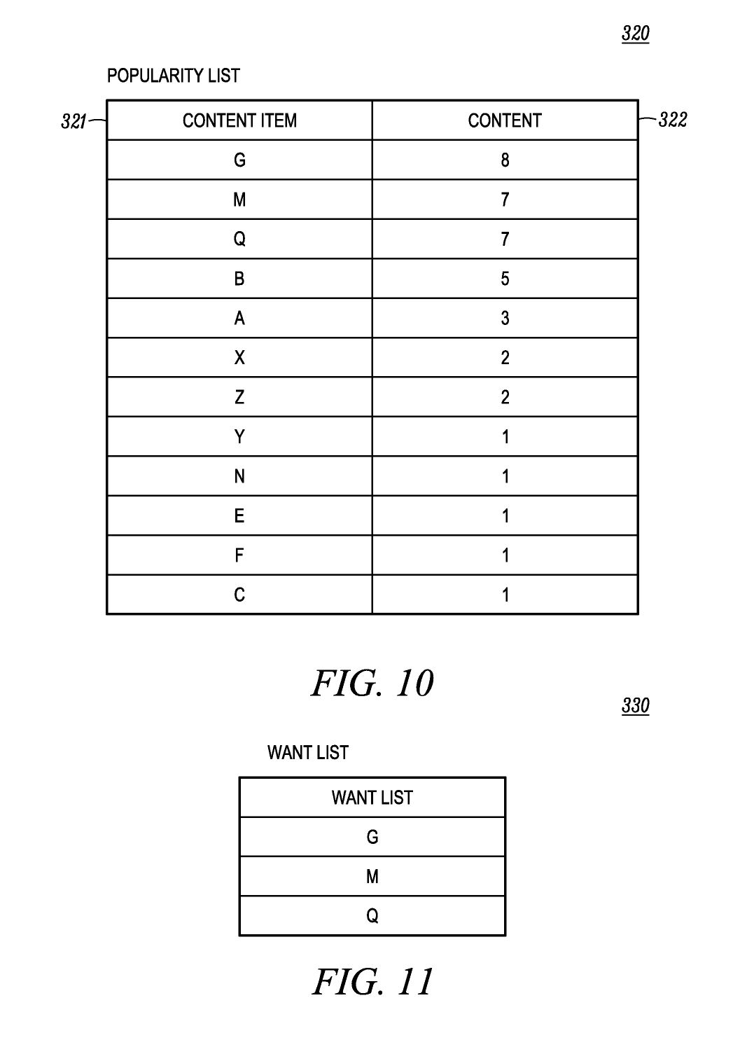

Returning back to FIG. 7, at step 206, a want-list can be created from the popular content identified in the plurality of requests. The popularity of the items from FIG. 9 are sorted to create the popularity list 320 in FIG. 10. The threshold 307 of FIG. 9 may be used to limit how many content items the super peer may want to obtain (called a “want-list”). The want-list (FIG. 11) can identify the most popular content wanted by one or more peers in the ahp2p environment 150 (See FIG. 4) that the super peer currently does not have but wants to obtain. For example, referring to FIG. 11, an exemplary want-list 320 is shown indicating the most popular items (items wanted by many peers) is G, M and Q. The want-list 330 generally includes the most popular content items requested, which the super peer has not yet loaded. In particular, referring back to FIG. 6, the super peer 110 can monitor the requests for content from each peer 171-172 and assemble the want-list 330 for the most popular content based on the requests. That is, the super peer 110 can create the want-list 330 for popular content based on the peer requests received.

Returning back to FIG. 7, at step 208, the want-list can be broadcast to the plurality of peers. The want-list contains a list of the most popular content requested by the peers that the super peer is now interested in obtaining. For example, referring to FIG. 13, the super peer 110 broadcasts the want list 330 (See FIG. 11) to the peers 171-173 in the ahp2p environment 150.

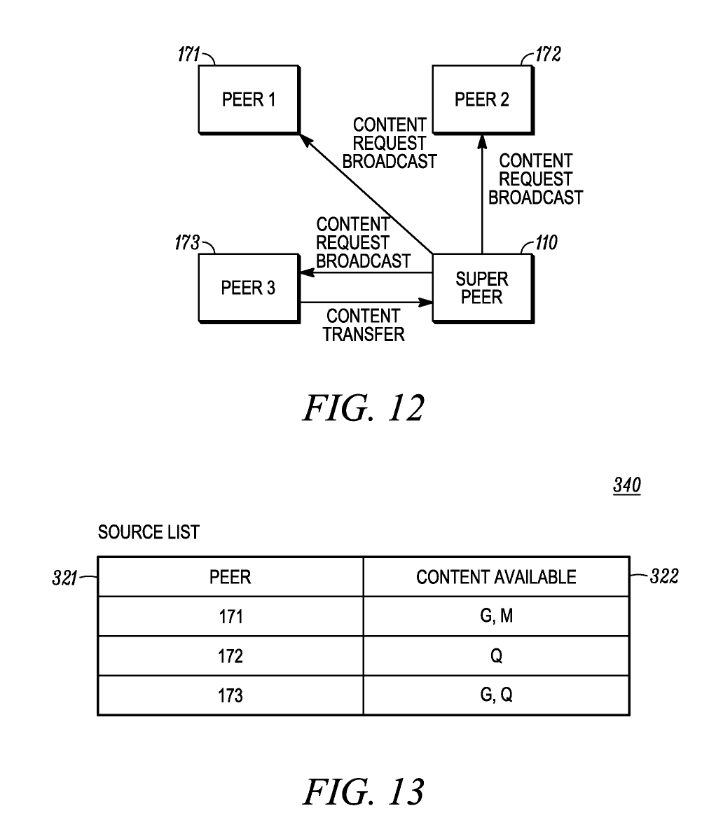

Returning back to FIG. 7, at step 210, at least one peer sourcing the popular content can be identified. That is, one or more peers in the ahp2p network 150 (See FIG. 13) may have the content available. Some of the peers may have content stored on the memory 114 (See FIG. 2) of the mobile device. For example, a user may have songs or files previously downloaded on the mobile device. The mobile device (e.g. peer 102) can evaluate the want-list and determine if any of the content on the want-list is stored in the memory 114. The want-list may be a text document containing a list of files which the mobile device use for comparison against files stored locally on the mobile device. For example, referring to FIG. 12, Peer 3 (173) may respond to the super peer 110 indicating that Peer 3 has content requested on the want-list 320.

Each peer in the source list may be able to source more than one content item. For example, FIG. 13 shows that peer 171 is capable of providing content items G and M whereas peer 172 can only source content item Q.

Returning back to FIG. 7, at step 212, the content can be acquired from the at least one peer. For example, referring to FIG. 13, a source list 340 is shown. The source list 340 identifies which peers have content on the want-list 330 (See FIG. 11). The source list 340 can include a list of peers 321 and the corresponding content 322 the peers have available. In practice, the super peer 110 can create the source-list 340 based on responses to the broadcasted want list 330 from the one or more peers in the ahp2p environment 120. It should also be noted that the want-list 330 (see FIG. 11), the popularity list 330 (See FIG. 10), and the source list 340 (See FIG. 13) may all be the same list and are only presented separately for illustration. Referring to FIG. 12, the super peer 110 can obtain content G from Peer 3 (173) in view of the source list 340. That is, the super peer 110 can gather the content from Peer 3 (173) and store the content locally on the high capacity memory 111 of the super peer 110 (See FIG. 4).

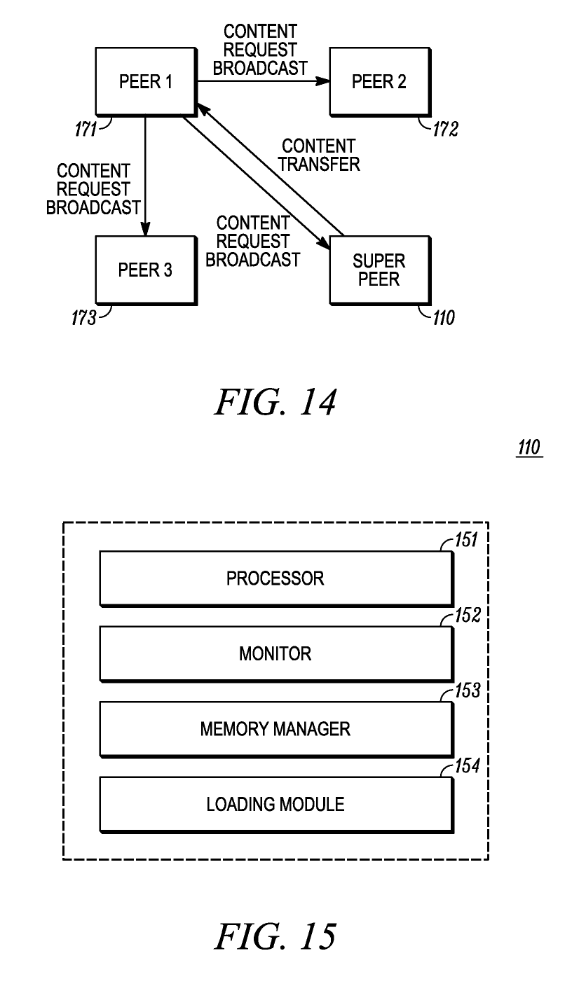

Returning back to FIG. 7, at step 214, the content can be distributed to the plurality of peers to offload content sourcing from the at least one peer as shown in FIG. 14. For example, Peer 1 (171) has requested content to Peer 2 (172) and Peer 3 (173). Super peer 110 has also received the content request and can source the content directly to Peer 1 (171). In particular, popular content gathered by the super peer 110 is distributed to Peer 1 (171) for preserving peer resources, such as battery power, or Peer 2 (172) and Peer 3 (173). This can reduce battery consumption by Peer 2 (172) and Peer 3 (173) and increase their data throughput capacity since sourcing responsibilities to Peer 1 (171) have been offloaded to the super peer 110. Moreover, the super peer 110 has substantial memory capacity and power for distributing popular content. At step 217 the method 700 can end.

Briefly, method 200 is directed to sharing content within an ahp2p environment wherein a super peer is introduced to offload content sourcing responsibilities from the peers. In summary, the method 200 as described included monitoring a plurality of requests, broadcasting a list of desired content base on the requests, obtaining a list of peers willing to source the content, establishing a connection with one of the peers having the content available and transferring the content to the super peer. It should be noted these steps may be modified slightly depending on the nature of the exact protocols used. It should also be noted the only information that is “public” (e.g. seen by all peers) is the broadcast of what content is desired. All other transactions are assumed to be secure and hidden for privacy reasons.

It should also be noted, that one objective of the super peer, in addition to gathering and distributing popular content, is to maximally fill a storage of the super peer with content that is popular. That is, the super peer manages popular content and keeps only the most popular content requested. In one arrangement, the super peer 110 performs a garbage collection for content items that are no longer in popular demand.

Briefly, referring to FIG. 15, a block diagram of the super peer 110 is shown. The super peer 110 may include more or less than the number of components shown. Briefly, the super peer 110 can include a processor 151, a monitor 152, a memory management 153, and a loading module 154. The processor 151 can manage the want list 320 (See FIG. 10) that identifies content wanted by the plurality of peers, the popularity list 330 (See FIG. 11) that ranks the content in the want list by popularity, and the source list 340 (See FIG. 13) that identifies peers capable of sourcing the content. The monitor can be coupled to the processor 151 for monitoring battery power levels from a plurality of peers. For example, referring to FIG. 6, the super peer 110 can overtake sourcing responsibilities of a peer when a battery power level of the peer falls below a threshold. The memory management module 153 can evaluate a capacity for popular content and excess storage capacity for acquiring the popular content. The loading module 154 can acquire popular content from a peer and source the popular content to the plurality of peers.

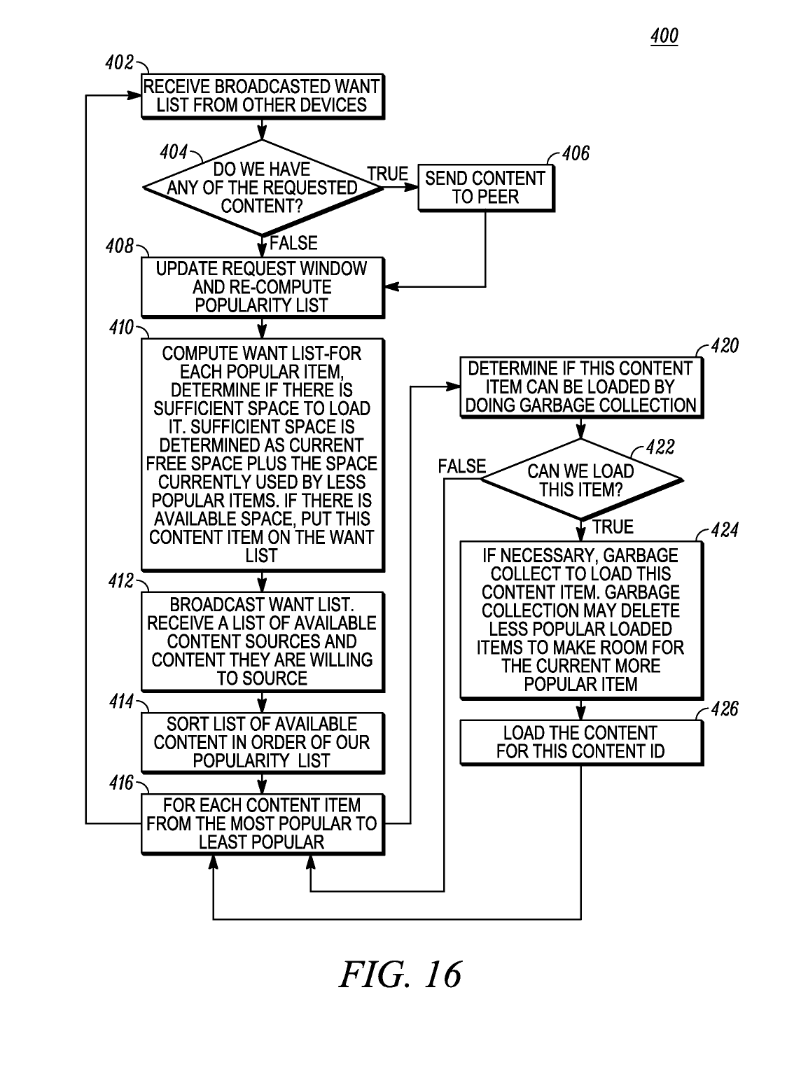

Referring to FIG. 16, a flowchart 400 for distributing content is shown in accordance with the principles of operation of the super peer. The flowchart 400 may include more or less than the number of steps shown, and is not limited to the order in which the steps are performed.

At step 402, the super peer 110 can receive a broadcasted want list from other devices (e.g. peers 102 in ahp2p 150). Briefly, the super peer 110 awaits content request broadcasts from surrounding peers. Once the super peer receives a content request broadcast, the super peer determines if it has any of the requested content. If it has any of the requested content, it sends the content to the peer that requested it. For example, at step 404, the super peer 110 determines if any of the requested content is available. That is, the super peer 110 determines if it has the content to distribute. The content may be available in the high capacity memory 111 (See FIG. 4) from a previous content request. If the super peer 110 has the content, it can distribute the content at step 406.

Having just received a broadcast requesting content, the super peer 110 can use the new content requests to update its window 302 (See FIG. 8) of requested content. Briefly referring to FIG. 8, the new content request is added to the window and the oldest requests are shifted out in computing the popularity. The super peer 110 then uses the updated window 302 information to compute the popularity list 320 (See FIG. 11). It should be noted the super peer may limit the requests by discarding the same content request from the same peer. This may be necessary to prevent a single device from “spamming” the super peer 110 by constantly requesting the same content item repeatedly. Thus, the window 302 would be affected only by different peers requesting the same content.

At step 410, the super peer 110 can update the want-list 330 (See FIG. 11). Notably, the want list 330 identifies popular content the super peer wants to load. It is important to note that although the super peer may want many items, what it can actually load is dependent on available storage, subject to maintaining only the most popular items; thus, the want-list generation is also subject to garbage collection. Briefly, referring back to FIG. 15, the memory manager 153 can determine if there is sufficient data space to load the content. The memory manager 153 evaluates the current excess data space plus space currently used by less popular items. If data space is available, the memory manager 153 puts the content in the want list 320 (See FIG. 10).

The memory manager 153 scans the popularity list (content IDs) from most popular to least popular. If the content has already been loaded, the content ID is not placed on the want list. If the content has not been loaded, then it is a potential candidate for loading and may be put on the want-list 320. The memory manager 153 then determines if there is sufficient data space to load the content ID requested on the want-list 320. Notably, the super peer 110 attempts to always keep the most popular items and thus occasionally deletes less popular items to load a more popular item. The memory manager 153 computes free space plus the total space of all less popular items that have already been loaded for determining if there is available space to load the content. The reason total space of all less popular items is considered as available space is the super peer may need to delete less popular items to load a more popular item. To constrain the want list to a practical size, the memory manager 153 may truncate the want list 320 to only content items where the popularity is above a specific threshold 307.

Returning back to FIG. 16, at step 412, the want-list can be broadcast to the plurality of peers. That is, once the popularity list has been computed, it can be broadcast to other peers. Other peers can respond with acknowledgements of what content they can source. At step 414, the list of available content can be sorted in order of the popularity list. Given that many peers may respond with different available content, the super peer must decide which content items are the most beneficial to load first. The solution the super peer uses is to assume the most important content to load is the most popular. Thus, the super peer sorts the source list 340 (See FIG. 13) according to the same order as the popularity list (FIG. 16, 414). When the source list 340 is sorted according to the same order as the popularity list, content G is available from both peer 171 and peer 173, content M is available from only peer 171, and content Q is available from both peer 172 and peer 173.

At step 416, a loop steps through the source list 340 according to the same ordering as the popularity list 320. This loop determines the order of the content items to load from other peers. In order for the super peer to load the most popular content first, the super peer will first request content item G from either peer 171 or peer 173, then request content item M from peer 171, and then request content Q from peer 172 or 173.

Returning back to FIG. 15, at step 420, it can be determined whether the content item can be loaded. This determination may require garbage collection, which can involve removing some of the content items currently in storage. For example, at step 422, it can be determined whether the item can be loaded. Briefly referring to FIG. 14, the memory manager 153 and the loading module 154 determine whether sufficient space exists for a particular content item.

Returning back to FIG. 15, at step 424, garbage collection can be performed to provide storage space required to load the content. Recall, the memory manager 153 computes available storage as the free storage plus the storage used by all lesser popular loaded content items. If there is insufficient available storage, the loading module 154 can not load the content item and the memory manager 153 steps to the next content available content item to fetch (FIG. 16, 416). If there is available storage, the memory manager 153 may delete less popular loaded content items (starting with the least popular) until there is sufficient available storage for the content item to load.

Returning back to FIG. 15, at step 426, the loading module 154 then loads the content from the peer. That is, the super peer 110 acquires the content from a peer capable of sourcing the popular content for broader distribution. Once the content item is loaded, the processor 151 (see FIG. 14) assigns a popularity value according to the previously computed popularity.

In summary, embodiments of the invention have been directed to a system and method for distributing content in an ad-hoc peer-to-peer (ahp2p) environment. In particular, a super peer has been provided that behaves as a true peer and which is indistinguishable from the other device. The super peer has the capability to source more content than peers due to having substantially more resources. In particular, the super peer has higher memory capacity and a sustaining power supply. The super peer enhances system distribution capacity by gathering and distributing popular content because it is not limited by storage or power.

Where applicable, the present embodiments of the invention can be realized in hardware, software or a combination of hardware and software. Any kind of computer system or other apparatus adapted for carrying out the methods described herein are suitable. A typical combination of hardware and software can be a mobile communications device with a computer program that, when being loaded and executed, can control the mobile communications device such that it carries out the methods described herein. Portions of the present method and system may also be embedded in a computer program product, which comprises all the features enabling the implementation of the methods described herein and which when loaded in a computer system, is able to carry out these methods.

While the preferred embodiments of the invention have been illustrated and described, it will be clear that the embodiments of the invention is not so limited. Numerous modifications, changes, variations, substitutions and equivalents will occur to those skilled in the art without departing from the spirit and scope of the present embodiments of the invention as defined by the appended claims.

What is claimed is:

1. A method for peer-to-peer content sharing, comprising:
monitoring a plurality of requests from a plurality of peers;
identifying a popular content from the plurality of requests;
sourcing the popular content from at least one peer; and
distributing the popular content to the plurality of peers.

2. The method of claim 1, further comprising:
creating a want-list for the popular content;
broadcasting the want-list of content to the plurality of peers;
identifying at least one peer sourcing the content; and
acquiring the content from the at least one peer.

3. The method of claim 2, further comprising:
offering a reward to the at least one peer providing the popular content.

4. The method of claim 1, wherein the identifying includes:
evaluating a number of requests for the content;
rating the content by the number of requests; and
identifying popular content from the rating,
wherein the super peer acquires popular content from at least one peer and distributes the popular content to the plurality of peers.

5. The method of claim 4, further comprising:
assessing a probability for redistributing the popular content; and
weighting the popularity in view of the probability,
wherein content is distributed based on the popularity and the probability.

6. The method of claim 1, wherein the popular content is distributed to peers.

7. A method for distributing content in an ad-hoc peer-to-peer environment, comprising:
receiving a want list for content from a plurality of peers;
assessing a popularity of the content from the want list;
evaluating a capacity for sourcing the content based on the popularity; and
sourcing the content based on the capacity, wherein the sourcing acquires the content and distributes the content to the plurality of peers.

8. The method of claim 7, further comprising distributing the content in accordance with a popularity of the content.

9. The method of claim 7, wherein assessing a popularity includes:
rating the content by a number of requests for the content in the broadcasted want list to produce a popularity list.

10. The method of claim 7, wherein the evaluating a capacity includes:
determining whether the content is available; and
computing a storage capacity for sourcing the content.

11. The method of claim 10, further comprising:
updating the broadcasted want list based on the availability of content and the storage capacity to produce an updated want list; and
updating the popularity list based on the updated want list.

12. The method of claim 11, further comprising:
broadcasting the updated want list;
identifying at least one peer capable of sourcing the content; and
producing a source list that identifies peers capable of sourcing the content.

13. The method of claim 12, further comprising:
sorting the source list in accordance with the popularity list; and
determining peers capable of sourcing the content; and
acquiring the content from the peers for distribution to the plurality of peers.

14. The method of claim 13, wherein acquiring the content further includes:
performing a garbage collection that deletes content based on the sorting, wherein the garbage collection frees storage capacity for acquiring the content

15. A system for distributing content in an ad-hoc peer-to-peer environment, comprising:
a plurality of peers; and
a super peer for:
monitoring a plurality of requests for content from the plurality of peers;
identifying a popular content from the plurality of requests; and
distributing the popular content to the plurality of peers to offload content sourcing responsibilities from the plurality of peers.

16. The system of claim 15, wherein the super peer further comprises a processor for:
managing a want list that identifies content wanted by the plurality of peers;
managing a popularity list that ranks the content in the want list by popularity; and
managing a source list that identifies peers capable of sourcing the content.

17. The system of claim 16, further comprising:
a monitor coupled to the processor for monitoring battery power levels of the plurality of peers, wherein the super peer overtakes sourcing responsibilities of a peer when a battery power level of the peer falls below a threshold, and wherein the super peer has continuous power for sourcing content,

18. The system of claim 16, further comprising:
a memory management module operatively coupled to the processor for evaluating a capacity for popular content and freeing storage capacity for acquiring the popular content.

19. The system of claim 16, further comprising:
a loading module operatively coupled to the memory management module for acquiring popular content from a peer and sourcing the popular content to the plurality of peers based on the capacity.

20. The system of claim 16, wherein the super peer further comprises:
a high-capacity memory for storing popular content; and
a high-power supply for distributing popular content.
